(19) United States
(12) Patent Application Publication
(10) Pub. No.: US 2013/0284915 A1
(43) Pub. Date: Oct. 31, 2013

(54) MASS SPECTROMETRY METHOD, MASS SPECTROMETER, AND MASS SPECTROMETRY SYSTEM

(71) Applicants: Haruo Shimada, Kanagawa (JP); Yoshimasa Nakatani, Kanagawa (JP); Yuka Noritake, Kanagawa (JP); Kazumasa Kinoshita, Kanagawa (JP); Yasuo Shida, Tokyo (JP)

(72) Inventors: Haruo Shimada, Kanagawa (JP); Yoshimasa Nakatani, Kanagawa (JP); Yuka Noritake, Kanagawa (JP); Kazumasa Kinoshita, Kanagawa (JP); Yasuo Shida, Tokyo (JP)

(73) Assignees: Bio Chromato, Inc., Kanagawa (JP); SHISEIDO COMPANY, LTD., Tokyo (JP)

(21) Appl. No.: 13/997,714

(22) PCT Filed: Dec. 26, 2011
(86) PCT No.: PCT/JP2011/080024

§ 371 Date: Jun. 25, 2013

(30) Foreign Application Priority Data
Dec. 27, 2010 (JP) 2010-290743

(51) Int. Cl. H01J 49/04

(52) U.S. Cl. CPC H01J 49/04
USPC 250/282; 250/281; 250/288

(57) ABSTRACT

A mass spectrometry method of the present invention is a method for conducting mass spectrometry in such a manner that an ion that is produced from a sample is introduced into a mass spectrometer by using DART or DESI, wherein the mass spectrometer has an ion introduction part for introducing the ion thereinto and the ion introduction part is heated at a predetermined timing.

### TECHNICAL FIELD

The present invention relates to a mass spectrometry method, a mass spectrometer, and a mass spectrometry system.

### BACKGROUND ART

While a variety of methods have been known as atmospheric pressure ionization methods, attention has been paid to DART (Direct Analysis in Real Time) or DESI (Desorption Electrospray Ionization) recently (see Patent Document 1).

DART is a method for colliding an atom or molecule in an electronically excited state with water in atmosphere to cause penning ionization thereof and adding a produced proton to a sample to cause ionization thereof. For example, when a helium in a metastable excited state He (2³S) is used, it is possible to ionize a sample M as follows.

He (2³S)+H₂O→H₂O⁺*+He (1¹S)+e⁻

H₂O⁺*H₂O→H₃O⁺+OH*

H₃O⁺+nH₂O→[(H₂O)ₙH]⁺

[(H₂O)ₙH]⁺+M→MH⁺+nH₂O

DESI is a method for attaching an ionized solvent to a sample to eliminate an ion.

However, there is a problem in that as mass spectrometry of an ion that is produced from a sample is conducted by using DART or DESI, an ion introduction part of a mass spectrometer is contaminated with an ion that is produced from a sample.

### PRIOR ART DOCUMENTS

### Patent Documents

Patent Document 1: Japanese Patent Application Publication No. 2008-180659

### SUMMARY OF THE INVENTION

Problems to be Solved by the Invention

While a problem that is possessed by a conventional technique as described above is taken into consideration, the present invention aims to provide a mass spectrometry method, a mass spectrometer, and a mass spectrometry system that are capable of suppressing contamination of an ion introduction part with an ion that is produced from a sample, even though mass spectrometry of an ion that is produced from a sample is conducted by using DART or DESI.

### Means for Solving the Problem

A mass spectrometry method of the present invention is a method for conducting mass spectrometry in such a manner that an ion that is produced from a sample is introduced into a mass spectrometer by using DART or DESI, wherein the mass spectrometer has an ion introduction part for introducing the ion thereinto and the ion introduction part is heated at a predetermined timing.

A mass spectrometry method of the present invention is a method for conducting mass spectrometry in such a manner that a sample is heated to generate a gas and an ion that is produced from the gas is introduced into a mass spectrometer by using DART, wherein the mass spectrometer has an ion introduction part for introducing the ion thereinto and the ion introduction part is heated at a predetermined timing.

A mass spectrometry method of the present invention is a method for conducting mass spectrometry in such a manner that DART is used and an ion that is produced from a gas that is generated by heating a sample is introduced into a mass spectrometer, wherein the mass spectrometer has an ion introduction part for introducing the ion thereinto and the ion introduction part is heated at a predetermined timing.

A mass spectrometer of the present invention is a mass spectrometer that is used in mass spectrometry for an ion that is produced from a sample by using DART or DESI and has an ion introduction part for introducing the ion thereinto and heating means for heating the ion introduction part.

A mass spectrometry system of the present invention has a DART ion source and/or DESI ion source and a mass spectrometer of the present invention.

### Effects of the Invention

According to the present invention, it is possible to provide a mass spectrometry method, a mass spectrometer, and a mass spectrometry system that are capable of suppressing contamination of an ion introduction part with an ion that is produced from a sample, even though mass spectrometry of an ion that is produced from a sample is conducted by using DART or DESI.

### BRIEF DESCRIPTION OF THE DRAWINGS

FIG. 1 is a schematic diagram that illustrates one example of a mass spectrometry method of the present invention.

FIG. 2 is a schematic diagram that illustrates another example of a mass spectrometer that is used in a mass spectrometry method of the present invention.

FIG. 3 is a schematic diagram that illustrates another example of an ion introduction tube that is used in a mass spectrometry method of the present invention.

FIG. 4 is a schematic diagram that illustrates one example of a method for heating a sample to generate a gas by applying an electric current to a resistance heating wire.

FIG. 5 is a schematic diagram that illustrates another example of a method for heating a sample to generate a gas by applying an electric current to a resistance heating wire.

FIG. 6 is a schematic diagram that illustrates another example of a method for heating a sample to generate a gas by applying an electric current to a resistance heating wire.

FIG. 7 is a schematic diagram that illustrates one example of a method for heating a sample by applying an electric current to a resistance heating wire.

FIG. 8 is a mass chromatogram at m/z=371 in Practical Example 1.

FIG. 9 is mass spectra at 2.0 min and 5.2 min in the mass chromatogram of FIG. 8.

FIG. 10 is a mass chromatogram at m/z=371 in Practical Example 2.

FIG. 11 is mass spectra at 2.0 min and 5.2 min in the mass chromatogram of FIG. 10.

FIG. 12 is a mass chromatogram at m/z=479 in Practical Example 3.

FIG. 13 is mass spectra at 1.8 min and 5.8 min in the mass chromatogram of FIG. 12.

### EMBODIMENTS FOR IMPLEMENTING THE INVENTION

Next, an embodiment(s) for implementing the present invention will be described in conjunction with the drawings.

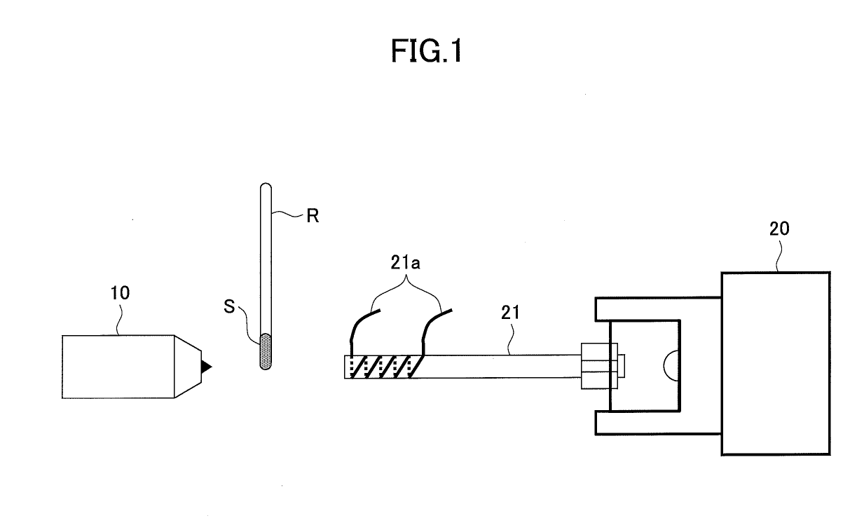

FIG. 1 illustrates one example of a mass spectrometry method of the present invention.

Mass spectrometry is conducted in such a manner that a helium in a metastable excited state He (2³S) is collided with water in atmosphere to cause penning ionization thereof by using a DART ion source 10, a sample S that is attached to a glass rod R is irradiated with a produced proton, and a produced ion is introduced into a mass spectrometer 20. Herein, because an ion introduction tube 21 of the mass spectrometer 20 is wrapped with a resistance heating wire 21a, a voltage is applied to the resistance heating wire 21a by using an electric power supply (not-illustrated), so that it is possible to heat the ion introduction tube 21. Thereby, it is possible to suppress contamination of the ion introduction tube 21 with an ion that is produced from the sample S. Herein, a pressure inside the ion introduction tube 21 is reduced by a compressor (not-illustrated).

Additionally, timing for heating the ion introduction tube 21 is not particularly limited.

For example, the ion introduction tube 21 may be heated after mass spectrometry of an ion that is produced from the sample S is conducted. In such a case, even though an ion that is produced from the sample S attaches to the ion introduction tube 21 as mass spectrometry of an ion that is produced from the sample S is conducted, it is possible to remove an ion that attaches to the ion introduction tube 21 after mass spectrometry of an ion that is produced from the sample S is conducted. As a result, it is possible to suppress contamination of the ion introduction tube 21 with an ion that is produced from the sample S.

Furthermore, mass spectrometry of an ion that is produced from the sample S may be conducted while the ion introduction tube 21 is heated. Thereby, as mass spectrometry of an ion that is produced from the sample S is conducted, it is possible to suppress attachment of an ion that is produced from the sample S to the ion introduction tube 21. As a result, it is possible to suppress contamination of the ion introduction tube 21 with an ion that is produced from the sample S. In such a case, the ion introduction tube 21 may also be heated after mass spectrometry of an ion that is produced from the sample S is conducted.

Additionally, because an ion that is produced from the sample S readily attaches to a side of the ion introduction tube 21 where an ion is introduced thereinto, a side of the ion introduction tube 21 where an ion is introduced thereinto is usually wrapped with the resistance heating wire 21a.

A temperature of an inner wall of the ion introduction tube 21 at a time when the ion introduction tube 21 is heated is usually 50-500° C., wherein 100-300° C. is preferable. If a temperature of an inner wall of the ion introduction tube 21 is less than 50° C., the ion introduction tube 21 may be contaminated with an ion that is produced from the sample S, and if one greater than 500° C. is provided, the mass spectrometer 20 may be adversely affected.

While a material for composing the ion introduction tube 21 is not particularly limited as long as a heat-resisting property is possessed, it is possible to provide a ceramic, a glass, Teflon (registered trademark), a stainless steel, a niobium steel, a tantalum steel, or the like.

An inner face of the ion introduction tube 21 may be coated with a fluororesin, a poly(etheretherketone), a silicone resin, or the like. Thereby, it is possible to further suppress attachment of an ion that is produced from the sample S to an inner wall of the ion introduction tube 21.

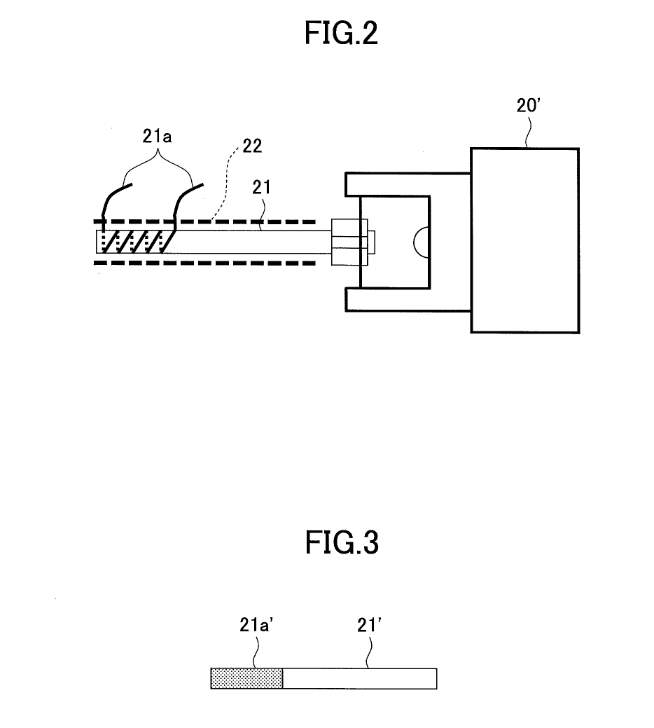

Furthermore, a heat insulation sheet 22 may be placed around the ion introduction tube 21 (see FIG. 2). Thereby, it is possible to suppress volatilization of the sample S due to heat that originates from the ion introduction tube 21. As a result, it is possible to improve precision of analysis of the sample S.

While a material for composing the heat insulation sheet 22 is not particularly limited, it is possible to provide a ceramic, a fluororesin, or the like.

While a material for composing the resistance heating wire 21a is not particularly limited, it is possible to provide a metal heating element such as an iron-chromium-aluminum-based alloy or a nickel-chromium-based alloy; a refractory metal heating element such as a platinum, a molybdenum, a tantalum, or a tungsten; a non-metal heating element such as a silicon carbide, a molybdenum-silicite, or a carbon; or the like.

Instead of the ion introduction tube 21 wrapped with the resistance heating wire 21a, a glass tube 21′ with an ITO film 21a′ that is formed thereon (see FIG. 3) is used and a voltage is applied to the ITO film 21a′ by using an electric power supply (not-illustrated) so that the glass tube 21′ may be heated. Thereby, a temperature of an inner wall of the glass tube 21′ is readily controlled and attachment of an ion that is produced from the sample S to the glass tube 21′ is readily confirmed.

Additionally, a method for heating the ion introduction tube 21 is not particularly limited and it is possible to provide a method for heating by using a ceramic fiber heater, a method for heating by being irradiated with a microwave, a method for heating by using a hot air device, or the like. Herein, instead of heating the ion introduction tube 21, an ion introduction port may directly be heated while the ion introduction tube 21 is detached.

Additionally, instead of a helium in a metastable excited state He (2³S), a neon in a metastable excited state, an argon in a metastable excited state, a nitrogen in a metastable excited state, or the like may be used.

While the sample S is not particularly limited as long as it is possible to produce an ion by using the DART ion source 10, it is possible to provide an organic compound or the like.

Additionally, an ionized solvent may be attached to a sample to eliminate an ion by using a DESI ion source instead of the DART ion source 10.

While a solvent to be ionized is not particularly limited, it is possible to provide a methanol, an aqueous solution of methanol, an acetonitrile, an aqueous solution of acetonitrile, or the like.

Additionally, a solvent to be ionized may contain an acidic substance or a basic substance.

While a sample is not particularly limited as long as it is possible to produce an ion by using a DESI ion source, it is possible to provide an organic compound or the like.

Additionally, mass spectrometry may be conducted in such a manner that a helium in a metastable excited state He (2³S) is collided with water in atmosphere to cause penning ionization thereof by using a DART ion source 10, a gas that is generated by heating a sample S is irradiated with a produced proton, and a produced ion is introduced into a mass spectrometer 20.

Thereby, when the sample S includes a polymer compound, an ion that is produced from a gas that is generated by pyrolyzing the polymer compound is introduced into the mass spectrometer 20, so that it is possible to analyze a structure of the polymer compound. Furthermore, a temperature for heating the sample S is changed continuously or stepwise, so that it is possible to introduce an ion that is produced from a gas that is generated by heating the sample S at each temperature into the mass spectrometer 20.

While a method for heating the sample S to generate a gas is not particularly limited, it is possible to provide a method for heating the sample S to generate a gas by applying an electric current to a resistance heating wire, a method for heating the sample S to generate a gas by using a ceramic fiber heater, a method for irradiating the sample S with a microwave to conduct heating thereof and generate a gas, a method for heating the sample S to generate a gas by using a hot air device, or the like.

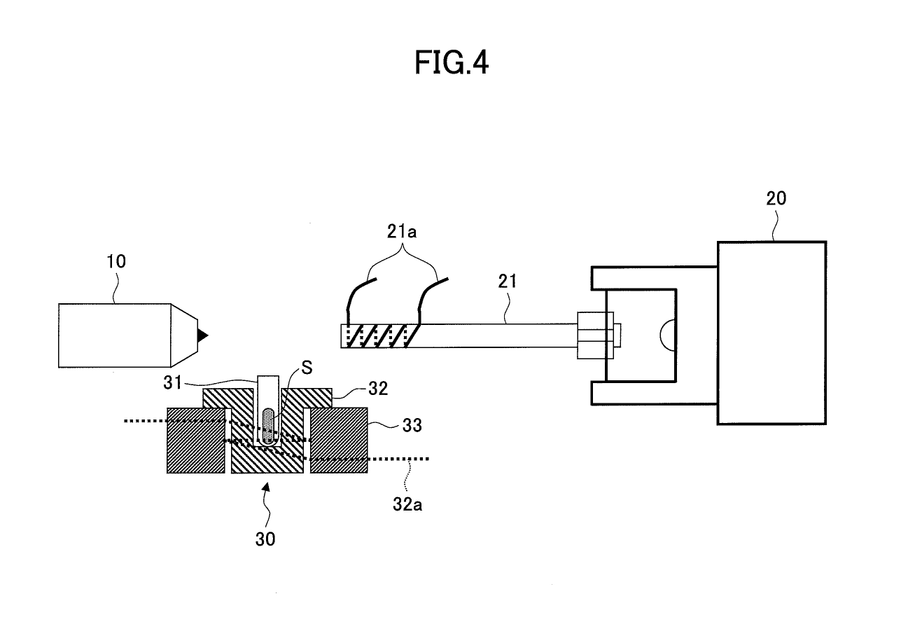

FIG. 4 illustrates one example of a method for heating the sample S to generate a gas by applying an electric current to a resistance heating wire. Additionally, only a heating device 30 is illustrated as a cross-sectional view in FIG. 4.

After the sample S is put into a pot 31, the pot 31 is held by a pot holding member 32. Herein, because the pot holding part 32 is wrapped with a resistance heating wire 32a, a voltage is applied to the resistance heating wire 32a by using an electric power supply (not-illustrated), so that it is possible to heat the pot holding member 32. Thereby, it is possible to heat the sample S to generate a gas. Furthermore, a heat insulation member 33 is placed around the pot holding member 32.

A temperature of the pot holding member 32 at a time when the sample S is heated is usually 50-1200° C., wherein 200-1000° C. is preferable. If a temperature of the pot holding member 32 is less than 50° C., it may be difficult to pyrolyze a polymer compound, and if one greater than 1200° C. is provided, the resistance heating wire 32a may be cut.

While a material for composing the pot 31 is not particularly limited as long as a heat-resisting property is possessed, it is possible to provide a glass, a quartz, or the like.

While a material for composing the pot holding member 32 is not particularly limited as long as a heat-resisting property is possessed, it is possible to provide a ceramic, a glass, a stainless steel, a niobium steel, a tantalum steel, or the like.

While a material for composing the resistance heating wire 32a is not particularly limited, it is possible to provide a metal heating element such as an iron-chromium-aluminum-based alloy or a nickel-chromium-based alloy; a refractory metal heating element such as a platinum, a molybdenum, a tantalum, or a tungsten; a non-metal heating element such as a silicon carbide, a molybdenum-silicite, or a carbon; or the like.

While a material for composing the heat insulation member 33 is not particularly limited as long as a heat-resisting property and a heat-insulating property are possessed, it is possible to provide a ceramic, a glass, a stainless steel, a niobium steel, a tantalum steel, or the like.

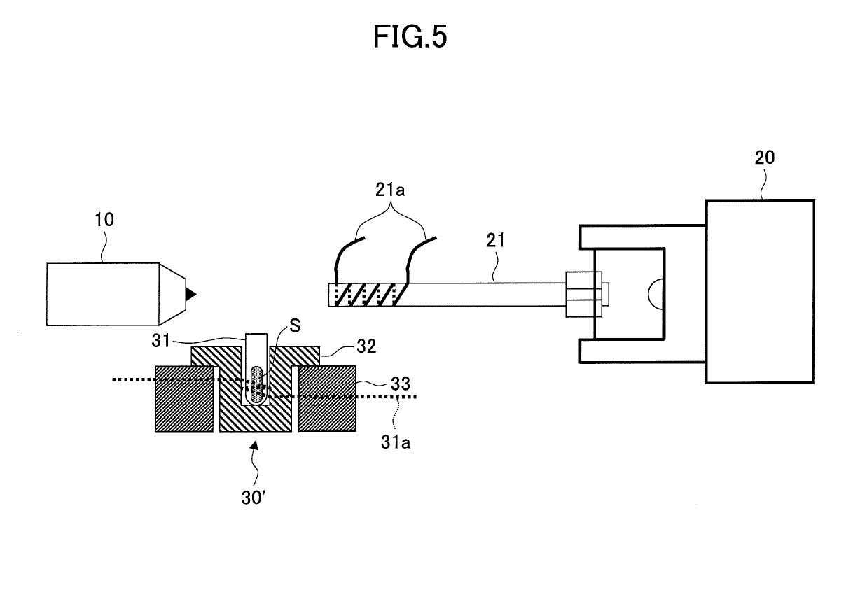

Additionally, the pot 31 may be wrapped with a resistance heating wire 31a (see FIG. 5) instead of wrapping the pot holding member 32 with the resistance heating wire 32a. Additionally, only a heating device 30′ is illustrated as a cross-sectional view in FIG. 5.

Furthermore, a heat source may be placed under the pot 31 without wrapping the pot holding member 32 with the resistance heating wire 32a.

While a heat source is not particularly limited, it is possible to provide a plate wherein a ceramic heater or a cartridge heater is embedded therein or the like.

While a material for composing a plate is not particularly limited as long as a heat conductance is favorable, it is possible to provide a copper, an aluminum, or the like.

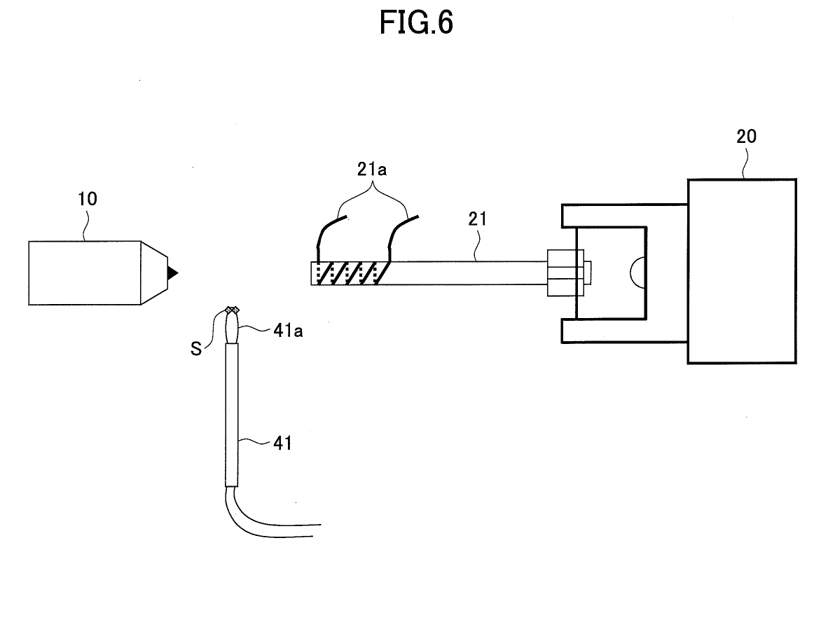

FIG. 6 illustrates another example of a method for heating the sample S to generate a gas by applying an electric current to a resistance heating wire.

After the sample S is attached to a resistance heating wire 41a that is supported by a resistance heating wire supporting member 41, a voltage is applied to the resistance heating wire 41a by using an electric power supply (not-illustrated), so that it is possible to heat the sample S to generate a gas.

A temperature of the resistance heating wire 41a at a time when the sample S is heated is usually 50-1200° C., wherein 200-1000° C. is preferable. If a temperature of the resistance heating wire 41a is less than 50° C., it may be difficult to pyrolyze a polymer compound, and if one greater than 1200° C. is provided, the resistance heating wire 41a may be cut.

While the resistance heating wire supporting member 41 is not particularly limited as long as a heat resisting property and an insulation property are possessed, it is possible to provide a ceramic, a glass, or the like.

While a material for composing the resistance heating wire 41a is not particularly limited, it is possible to provide a metal heating element such as an iron-chromium-aluminum-based alloy or a nickel-chromium-based alloy; a refractory metal heating element such as a platinum, a molybdenum, a tantalum, or a tungsten; a non-metal heating element such as a silicon carbide, a molybdenum-silicite, or a carbon; or the like.

Furthermore, mass spectrometry may be conducted in such a manner that a sample S is heated, a helium in a metastable excited state He (2³S) is collided with water in atmosphere to cause penning ionization thereof by using a DART ion source 10, and an ion that is produced by irradiating the sample S with a produced proton is introduced into a mass spectrometer 20.

Thereby, when the sample S includes a polymer compound, an ion that is produced from a gas that is generated by pyrolyzing the polymer compound is introduced into the mass spectrometer 20, so that it is possible to analyze a structure of the polymer compound.

While a method for heating the sample S is not particularly limited, it is possible to provide a method for heating the sample S by applying an electric current to a resistance heating wire, a method for heating the sample S by using a ceramic fiber heater, a method for irradiating the sample S with a microwave to be heated, a method for heating the sample S by using a hot air device, or the like.

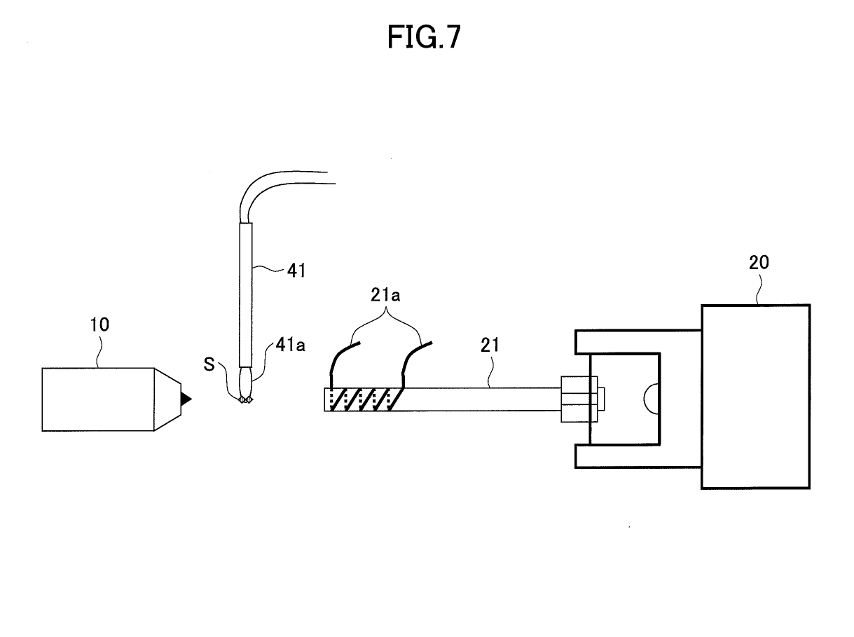

FIG. 7 illustrates one example of a method for heating the sample S by applying an electric current to a resistance heating wire.

After the resistance heating wire 41a that is supported by the resistance heating wire supporting member 41 is attached to the sample S, a voltage is applied to the resistance heating wire 41a by using an electric power supply (not-illustrated), so that it is possible to heat the sample S.

A temperature of the resistance heating wire 41a at a time when the sample S is heated is usually 50-1200° C., wherein 200-1000° C. is preferable. If a temperature for heating the sample S is less than 50° C., it may be difficult to pyrolyze a polymer compound, and if one greater than 1200° C. is provided, the resistance heating wire 41a may be cut.

### PRACTICAL EXAMPLES

### Practical Example 1

A glass rod was dipped in a 5% by mass solution of a polyethylene glycol with an average molecular weight of 400 in methanol so that the polyethylene glycol was attached to the glass rod R as a sample S.

Then, mass spectrometry of an ion that was produced from the polyethylene glycol was conducted by using the mass spectrometry method in FIG. 1. Specifically, first, while a helium in a metastable excited state He (2³S) was collided with water in atmosphere to cause penning ionization thereof by using a DART ion source 10 and the polyethylene glycol that was attached to the glass rod R was irradiated with a produced proton, a produced ion was introduced into a mass spectrometer 20 so that mass spectrometry was conducted (1.5-3 min). Then, the Dart ion source 10 was stopped (3-6 min). Moreover, an ion introduction tube 21 was heated by applying an electric current of 4.5 A to a resistance heating wire 21a (5-6 min). Herein, a temperature of an inner wall of the ion introduction tube 21 was elevated from 19-23° C. to 170-270° C.

Additionally, DART SVP (produced by IonSense Inc.) was used as the DART ion source 10, wherein a preset temperature of a gas heater was 500° C. Furthermore, MicrOTOFQII (produced by Bruker Daltonics K. K.) was used as the mass spectrometer 20, wherein a measurement mode was a positive ion mode. Moreover, a tube made of a ceramic with an outer diameter of 6.2 mm, an inner diameter of 4.7 mm, and a length of 94 mm was used as the ion introduction tube 21, and wrapped with the resistance heating wire 21a on an area no more than 35 mm from a side where an ion was introduced. Herein, a nichrome wire with a diameter of 0.26 mm was used as the resistance heating wire 21a.

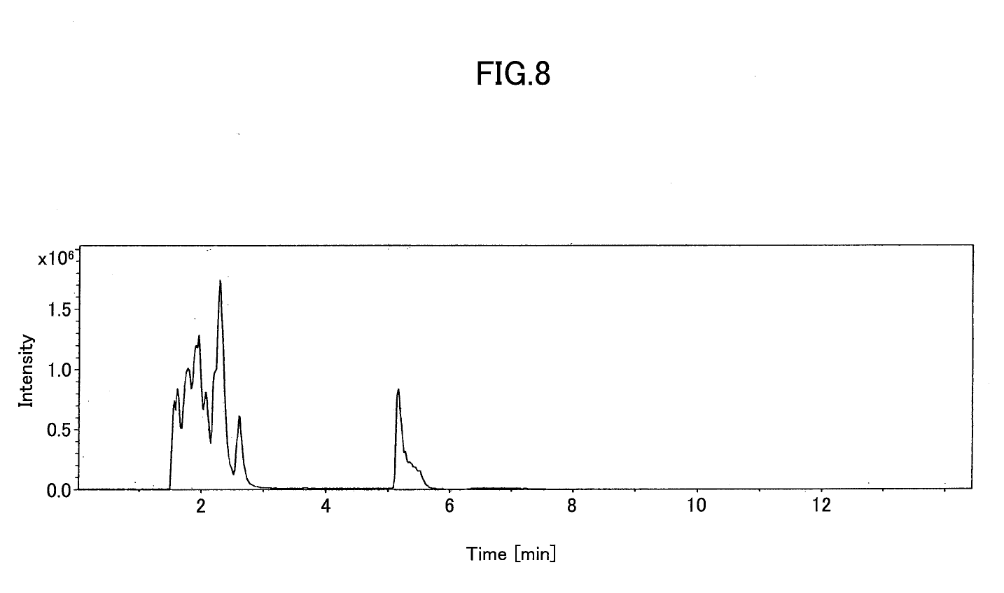

FIG. 8 illustrates a mass chromatogram at m/z=371. Additionally, m/z=371 is a mass-to-electric-charge ratio of an ion that was produced from the polyethylene glycol.

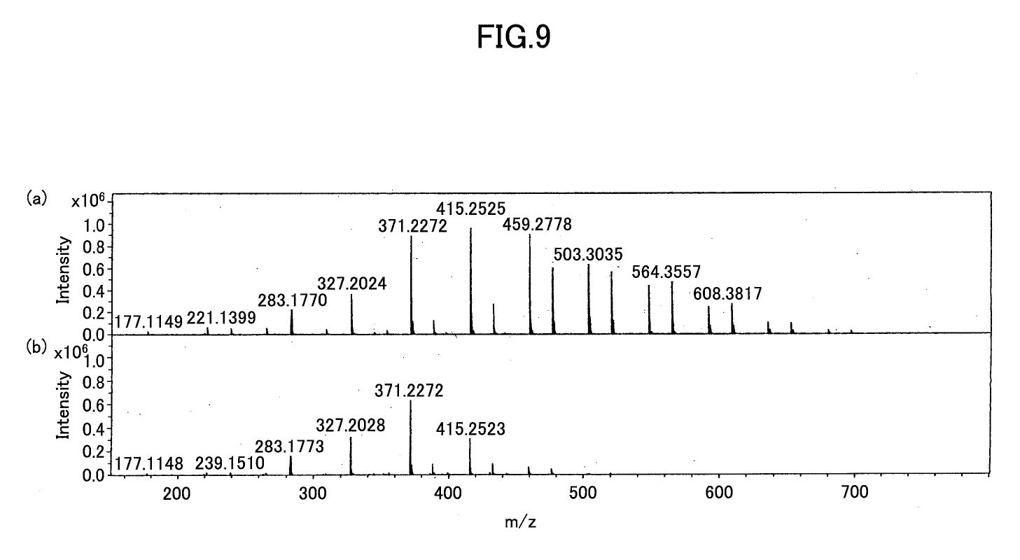

FIG. 9 (a) and (b) illustrate mass spectra at 2.0 min and 5.2 min in the mass chromatogram of FIG. 7, respectively. It can be seen from FIG. 9 that peaks that originated from the polyethylene glycol were present in mass spectra at 2.0 min and 5.2 min in the mass chromatogram of FIG. 8. Accordingly, it can be understood from FIG. 8 that when mass spectrometry of an ion that was produced from the polyethylene glycol was conducted, an ion that was produced from the polyethylene glycol was attached to the ion introduction tube 21, but after mass spectrometry of an ion that was produced from the polyethylene glycol was conducted, it was possible to remove an ion that was produced from the polyethylene glycol and attached to the ion introduction tube 21. Accordingly, it can be understood that after mass spectrometry of an ion that was produced from the polyethylene glycol was conducted, it was possible to heat the ion introduction tube 21 so as to suppress contamination of the ion introduction tube 21 with an ion that was produced from the polyethylene glycol.

### Practical Example 2

A glass rod R was dipped in a 5% by mass solution of a polyethylene glycol with an average molecular weight of 400 in methanol so that the polyethylene glycol was attached to the glass rod R as a sample S.

Then, mass spectrometry of an ion that was produced from the polyethylene glycol was conducted by using the mass spectrometry method in FIG. 1. Specifically, first, while a helium in a metastable excited state He (2³S) was collided with water in atmosphere to cause penning ionization thereof by using a DART ion source 10 and the polyethylene glycol that was attached to the glass rod R was irradiated with a produced proton, a produced ion was introduced into a mass spectrometer 20 so that mass spectrometry was conducted (1.5-3 min). Additionally, an ion introduction tube 21 was heated by applying an electric current of 4.5 A to a resistance heating wire 21a (1-4 min). Herein, a temperature of an inner wall of the ion introduction tube 21 was elevated from 19-23° C. to 170-270° C. Then, the DART ion source 10 was stopped (3.2-6 min). Furthermore, an electric current that was applied to the resistance heating wire 21a was 0 A (4-5 min). Moreover, the ion introduction tube 21 was heated by applying an electric current of 4.5 A to the resistance heating wire 21a (5-6 min). Herein, a temperature of an inner wall of the ion introduction tube 21 was elevated to 170-270° C.

Additionally, DART SVP (produced by IonSense Inc.) was used as the DART ion source 10, wherein a preset temperature of a gas heater was 500° C. Furthermore, MicrOTOFQII (produced by Bruker Daltonics K. K.) was used as the mass spectrometer 20, wherein a measurement mode was a positive ion mode. Moreover, a tube made of a ceramic with an outer diameter of 6.2 mm, an inner diameter of 4.7 mm, and a length of 94 mm was used as the ion introduction tube 21, and wrapped with the resistance heating wire 21a on an area no more than 35 mm from a side where an ion was introduced. Herein, a nichrome wire with a diameter of 0.26 mm was used as the resistance heating wire 21a.

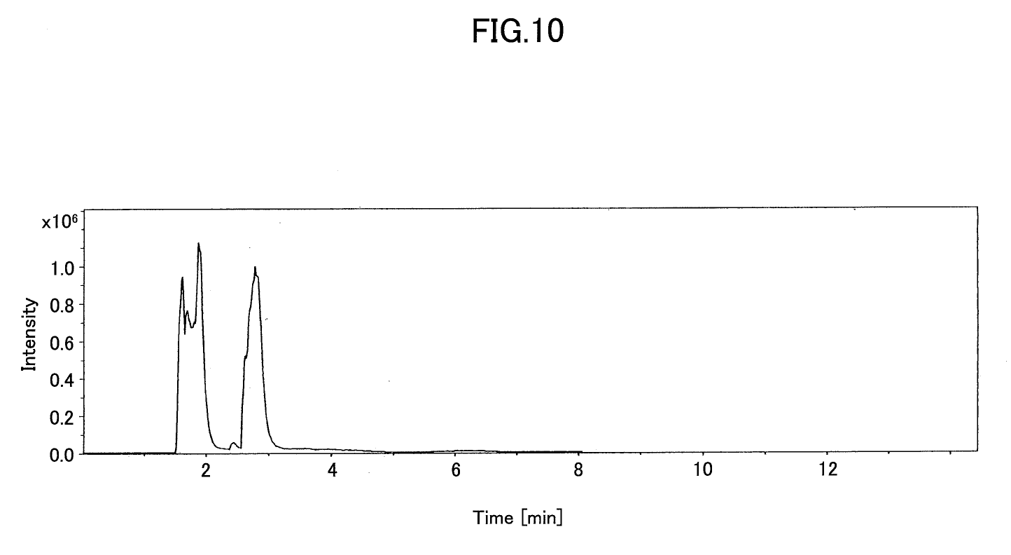

FIG. 10 illustrates a mass chromatogram at m/z=371.

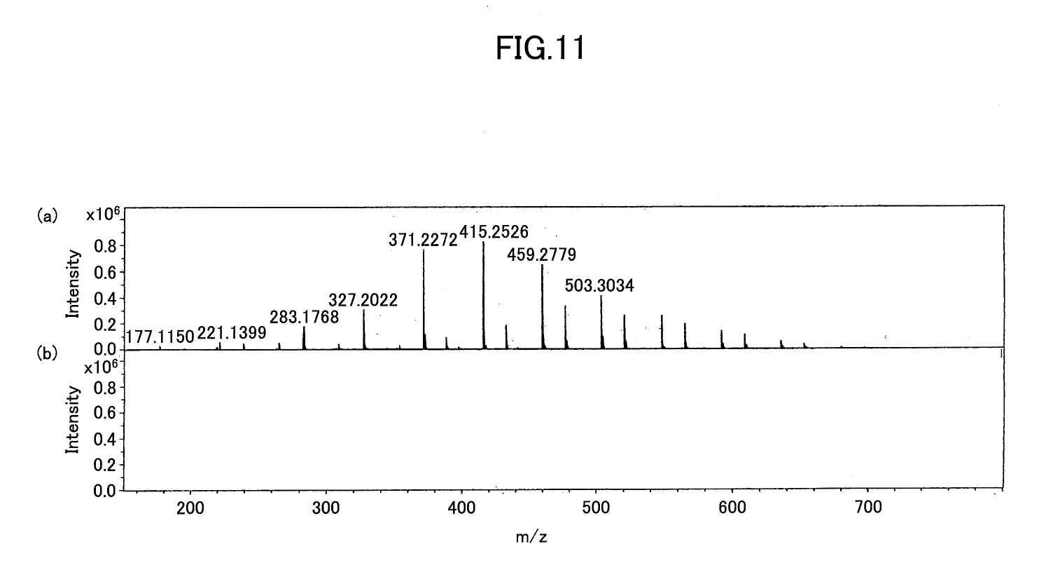

FIG. 11 (a) and (b) illustrate mass spectra at 2.0 min and 5.2 min in the mass chromatogram of FIG. 10, respectively.

It can be seen from FIG. 11 that a peak that originated from the polyethylene glycol was present in a mass spectrum at 2.0 min in the mass chromatogram of FIG. 10. On the other hand, it can be seen that a peak that originated from the polyethylene glycol was not present in a mass spectrum at 5.2 min in the mass chromatogram of FIG. 10. Accordingly, it can be understood from FIG. 10 that when mass spectrometry of an ion that was produced from the polyethylene glycol was conducted, it was possible to suppress attachment of an ion that was produced from the polyethylene glycol to the ion introduction tube 21. Accordingly, it can be understood that when mass spectrometry of an ion that was produced from the polyethylene glycol was conducted, it was possible to heat the ion introduction tube 21 so as to suppress contamination of the ion introduction tube 21 with an ion that was produced from the polyethylene glycol.

### Practical Example 3

After a polypropylene, as a sample S, was put into a pot 31 made of a heat-resisting glass, the pot 31 was held by a pot holding member 32.

Then, mass spectrometry of an ion that was produced from a gas that was generated by heating the polypropylene was conducted by using a method for heating the sample S to generate a gas by using the resistance heating wire in FIG. 4. Specifically, first, while a helium in a metastable excited state He (2³S) was collided with water in atmosphere to cause penning ionization thereof by using a DART ion source 10 and a gas that was generated by heating the polypropylene was irradiated with a produced proton, a produced ion was introduced into a mass spectrometer 20 so that mass spectrometry was conducted (1-3 min). Herein, the pot holding member 32 was heated to 570° C. by applying an electric current of 4.5 A to a resistance heating wire 32a. Then, the DART ion source 10 was stopped (3-7.8 min). Moreover, the ion introduction tube 21 was heated by applying an electric current of 4.5 A to the resistance heating wire 21a (5.6-7.8 min). Herein, a temperature of an inner wall of the ion introduction tube 21 was elevated from 19-23° C. to 170-270° C.

Additionally, DART SVP (produced by IonSense Inc.) was used as the DART ion source 10, wherein a preset temperature of a gas heater was 500° C. Furthermore, MicrOTOFQII (produced by Bruker Daltonics K. K.) was used as the mass spectrometer 20, wherein a measurement mode was a positive ion mode. Moreover, a tube made of a ceramic with an outer diameter of 6.2 mm, an inner diameter of 4.7 mm, and a length of 94 mm was used as the ion introduction tube 21, and wrapped with the resistance heating wire 21a on an area no more than 35 mm from a side where an ion was introduced. Herein, a nichrome wire with a diameter of 0.26 mm was used as the resistance heating wire 21a. Furthermore, while the pot holding member 32 made of a ceramic was used and a nichrome wire with a diameter of 0.32 mm was used as the resistance heating wire 32a, a heat insulation member 33 made of a ceramic was used.

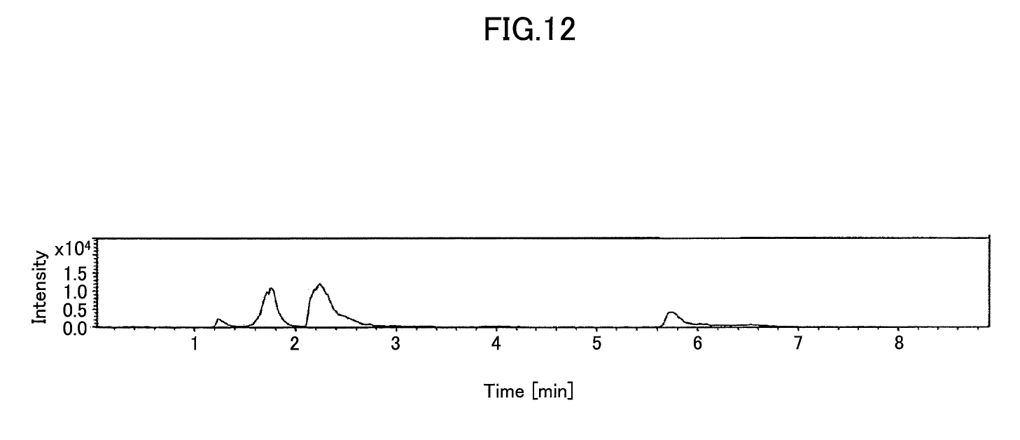

FIG. 12 illustrates a mass chromatogram at m/z=479. Additionally, m/z=479 is a mass-to-electric-charge ratio of an ion that was produced from the polypropylene.

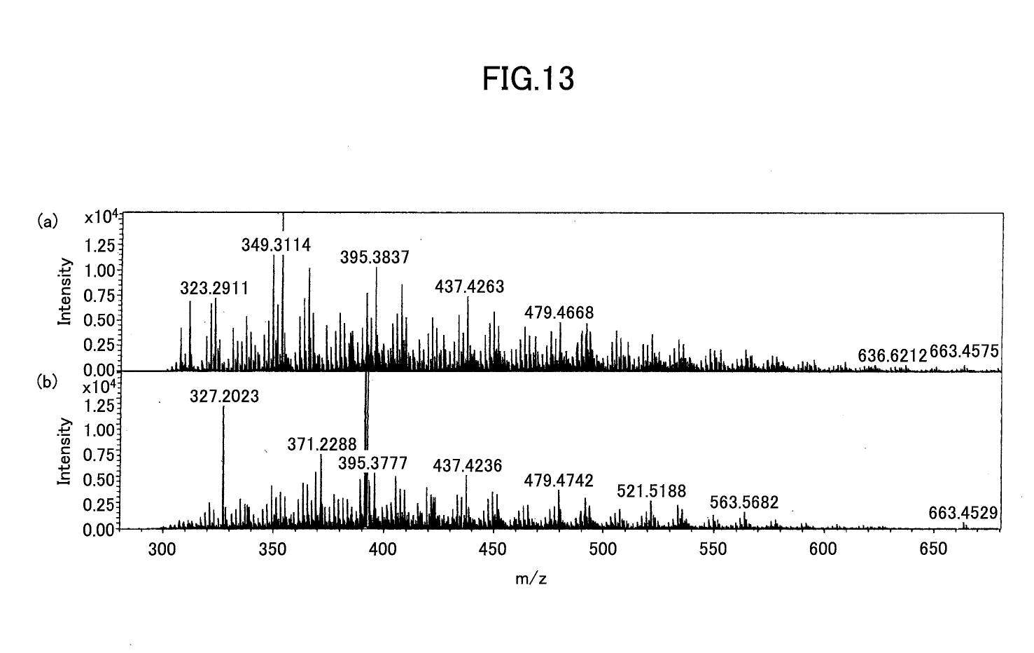

FIG. 13 illustrates mass spectra at 1.8 min and 5.8 min in the mass chromatogram of FIG. 12.

It can be seen from FIG. 13 that peaks that originated from the polypropylene were present in mass spectra at 1.8 min and 5.8 min in the mass chromatogram of FIG. 12. Accordingly, it can be understood from FIG. 12 that when mass spectrometry of an ion that was produced from a gas that was generated by heating polypropylene was conducted, an ion that was produced from a gas that was generated by heating the polypropylene was attached to the ion introduction tube 21, but after mass spectrometry of an ion that was produced from a gas that was generated by heating the polypropylene was conducted, it was possible to remove an ion that was produced from a gas that was generated by heating the polypropylene and attached to the ion introduction tube 21. Accordingly, it can be understood that after mass spectrometry of an ion that was produced from a gas that was generated by heating the polypropylene was conducted, it was possible to heat the ion introduction tube 21 so as to suppress contamination of the ion introduction tube 21 with an ion that was produced from a gas that was generated by heating the polypropylene.

The present international application claims priority based on Japanese Patent Application No. 2010-290743 filed on Dec. 27, 2010, and the entire content of Japanese Patent Application No. 2010-290743 is incorporated by reference in the present international application.

### EXPLANATION OF LETTERS OR NUMERALS

10: DART ion source

20, 20′: mass spectrometer

21: ion introduction tube

21′: glass tube

21a: resistance heating wire

21a′: ITO film

22: heat insulation sheet

30, 30′: heating device

31: pot

31a: resistance heating wire

32: pot holding member

32a: resistance heating wire

33: heat insulation member

41: resistance heating wire supporting member

41a: resistance heating wire

R: glass rod

S: sample

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A mass spectrometry method, comprising:
producing an ion from a sample by using DART or DESI;
introducing the ion into a mass spectrometer, the mass spectrometer including an ion introduction part configured to introduce the ion thereinto; and
heating the ion introduction part at a predetermined timing.

18. The mass spectrometry method as claimed in claim 17, wherein the ion introduction part is heated after an ion is produced from the sample.

19. The mass spectrometry method as claimed in claim 17, wherein the ion introduction part is heated while mass spectrometry is conducted.

20. The mass spectrometry method as claimed in claim 17, wherein the ion introduction part is a tube wrapped with a resistance heating wire and a voltage is applied to the resistance heating wire to heat the ion introduction part.

21. The mass spectrometry method as claimed in claim 20, wherein a heat insulation sheet is placed around the tube.

22. The mass spectrometry method as claimed in claim 17, wherein the ion introduction part is a glass tube with an ITO film formed thereon and a voltage is applied to the ITO film to heat the ion introduction part.

23. The mass spectrometry method as claimed in claim 22, wherein a heat insulation sheet is placed around the glass tube.

24. A mass spectrometry method, comprising:
heating a sample to generate a gas;
producing an ion from the gas by using DART;
introducing the ion into a mass spectrometer, the mass spectrometer including an ion introduction part configured to introduce the ion thereinto; and
heating the ion introduction part at a predetermined timing.

25. The mass spectrometry method as claimed in claim 24, wherein a voltage is applied to a resistance heating wire to heat the sample.

26. A mass spectrometer, comprising:
an ion introduction part configured to introduce an ion produced from a sample by using DART or DESI into the mass spectrometer; and
a heating device configured to heat the ion introduction part.

27. The mass spectrometer as claimed in claim 26, wherein the ion introduction part is a tube wrapped with a resistance heating wire and the mass spectrometer further includes a voltage applying device configured to apply a voltage to the resistance heating wire.

28. The mass spectrometer as claimed in claim 27, wherein a heat insulation sheet is placed around the tube.

29. The mass spectrometer as claimed in claim 26, wherein the ion introduction part is a glass tube with an ITO film formed thereon and the mass spectrometer further includes a voltage applying device configured to apply a voltage to the ITO film.

30. The mass spectrometer as claimed in claim 29, wherein a heat insulation sheet is placed around the glass tube.

31. A mass spectrometry system, comprising:
a DART ion source or a DESI ion source or a combination thereof; and
the mass spectrometer as claimed in claim 26.
